(19) United States
(12) Patent Application Publication
(10) Pub. No.: US 2022/0074342 A1
(43) Pub. Date: Mar. 10, 2022

(54) SUPERCHARGER WITH TWO COMPRESSORS DRIVEN TOGETHER ON A SINGLE SHAFT

(71) Applicant: Bullseye Power, LLC, Muskegon, MI (US)

(72) Inventor: David M. Hall, Muskegon, MI (US)

(73) Assignee: Bullseye Power, LLC, Muskegon, MI (US)

(21) Appl. No.: 17/362,325

(22) Filed: Jun. 29, 2021

Related U.S. Application Data
(63) Continuation-in-part of application No. 17/017,181, filed on Sep. 10, 2020.

(51) Int. Cl. F02B 33/40

(52) U.S. Cl. CPC F02B 33/40

(57) ABSTRACT

A supercharger for an internal combustion engine includes two compressors, each having a compressor wheel mounted on a common shaft, and a mechanical linkage for transmitting power from a running engine to the common shaft to provide a desired boost with less torque by using two smaller compressor wheels rather than a single larger compressor wheel.

### CROSS-REFERENCE TO RELATED APPLICATIONS

This application is a continuation-in-part of U.S. application Ser. No. 17/017,181, filed on Sep. 10, 2020, which is incorporated herein by reference in its entirety.

### FIELD OF THE DISCLOSURE

This disclosure relates to superchargers for internal combustion engines.

### BACKGROUND OF THE DISCLOSURE

Superchargers comprise a compressor for increasing the pressure or density of air supplied to an internal combustion engine. Power for the supercharger is provided by a mechanical linkage between the crankshaft of the internal combustion engine and the compressor.

### SUMMARY OF THE DISCLOSURE

Disclosed is a supercharger employing two compressors driven by a power takeoff from a running engine. More specifically, each compressor has a compressor wheel, wherein the compressor wheels are fixed on a single rotatable shaft mechanically linked to and driven by the running engine. This arrangement provides a given boost with less torque by using two smaller compressor wheels rather than a single larger compressor wheel.

### BRIEF DESCRIPTION OF THE DRAWINGS

FIG. 1A is a perspective view of the disclosed supercharger in which power is transmitted from the running engine to the compressor wheels by a bolt or chain.

FIG. 1B is a perspective view of the disclosed supercharger in which power is transmitted from a running engine to the compressors of the supercharger by a power take-off shaft.

FIG. 2 is a schematic depiction of a supercharged engine employing a supercharger in accordance with this disclosure.

FIG. 3 is a perspective view of a compressor as shown in FIG. 1, with a portion of one of the compressor housings broken away to show the volute and compressor wheel.

FIG. 4 is a perspective view of another embodiment of the disclosed supercharger system or arrangement.

### DETAILED DESCRIPTION

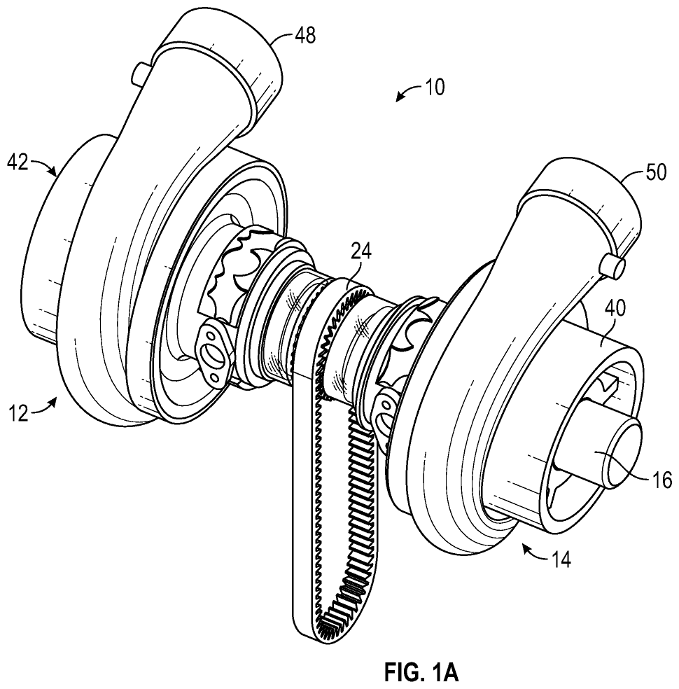

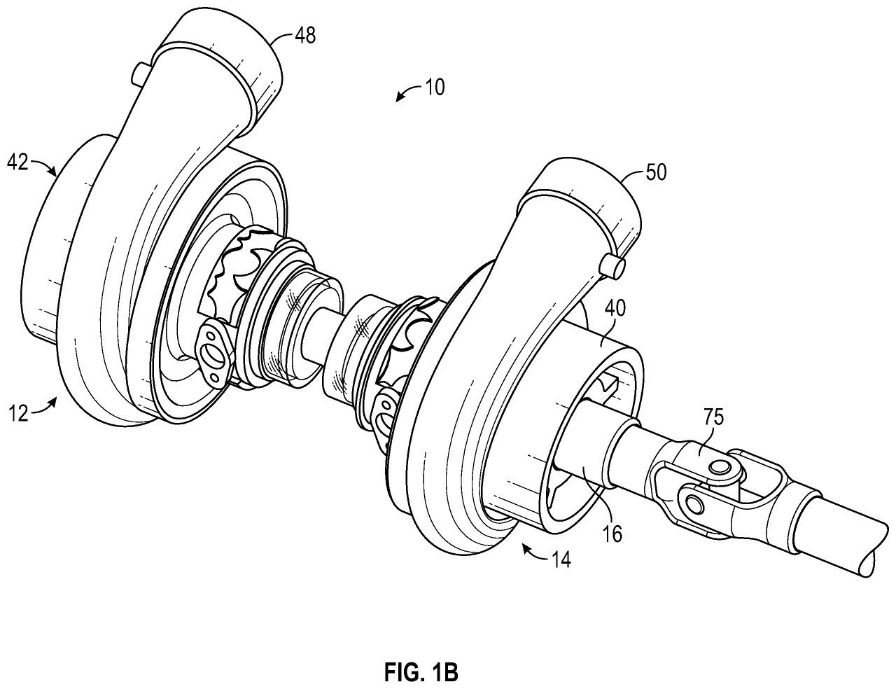

A supercharger 10 in accordance with this disclosure is shown in FIG. 1. Supercharger 10 includes a first compressor 12 having a first compressor wheel 14 fixed on a rotatable shaft 16, a second compressor 18 having a second compressor wheel 20 fixed on the shaft 16, and a mechanical linkage 70 (e.g., a belt, chain or drive shaft) for transmitting power from a running engine to shaft 16. In this arrangement, both compressor wheels (14, 18) rotate together on shaft 16 at the same rotational speed.

An alternative mechanical linkage for transmitting power from a running engine to shaft 16 is shown in FIG. 1B. Specifically, belt or chain 70 is replaced by a power take-off shaft 75.

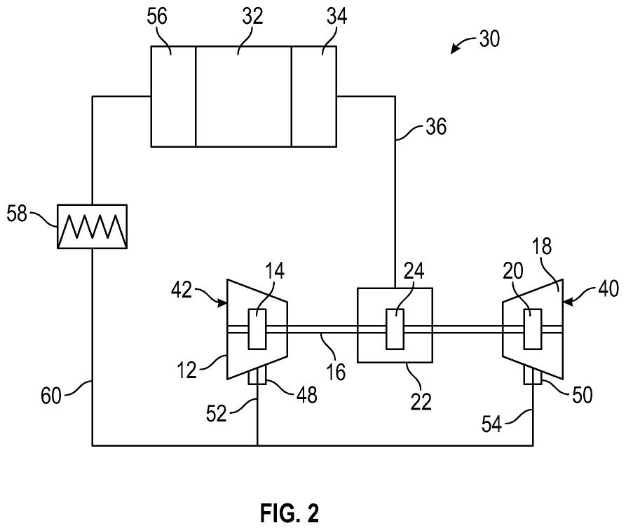

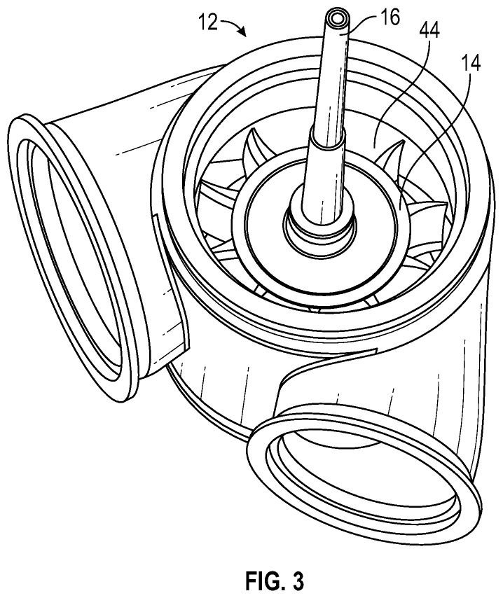

A supercharged internal combustion engine system 30 is shown in FIG. 2. System 30 includes, in addition to turbocharger 10, an internal combustion engine 32 (e.g., diesel or gasoline) having associated therewith a power take-off 34 and a mechanical linkage (belt, chain or shaft) 36 for transmitting power from running engine 32 to shaft 16. Compressors 12 and 18 include air inlets 40, 42 for drawing ambient air into the compressor volute 44 (FIG. 3).

Compressors 12 and 18 can include compressed air outlets and compressed air conduits 52, 54 for conveying compressed air from the compressors to an air intake manifold 56 associated with engine 32. As is typically the case, system 30 can be provided with an intercooler 58 for reducing the temperature of the compressed air before it enters manifold 56 and engine 32.

In the illustrated embodiment, air inlet 42 for first compressor 12 is parallel with the air inlet 40 for second compressor 14, and air outlet of first compressor 12 is parallel with air outlet 50 of second compressor 14. Also, in the illustrated embodiments, compressor 12 has a housing and volute 44 that is substantially a mirror image of housing and volute 46 of compressor 14.

In the illustrated embodiment, conduit 60 is provided for combining and conveying compressed air from the first compressor and the second compressor to the air intake manifold.

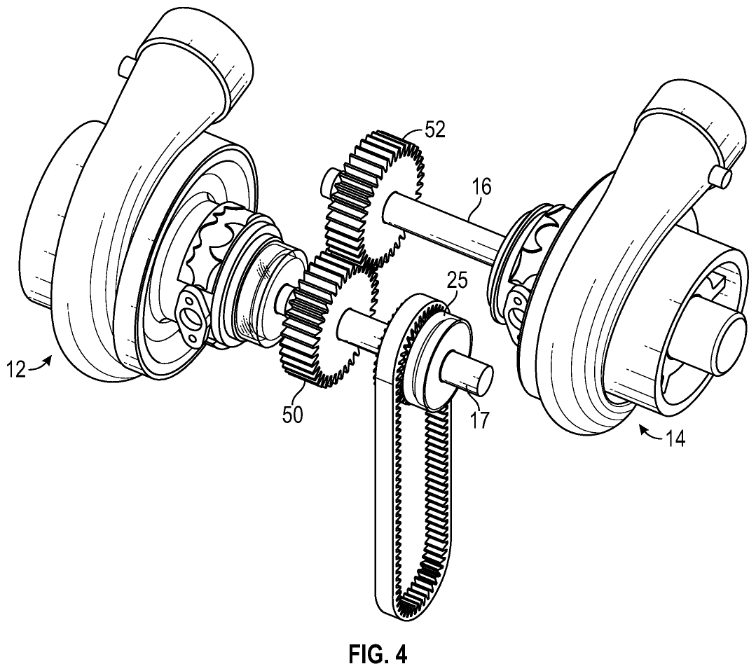

Shown in FIG. 4 is another embodiment in which compressor 12 is fixed on shaft 17 and is driven by belt 24 meshing with gear 25 also fixed to shaft 17. A second gear 50 is fixed on shaft 17 and meshes with a third gear 52 fixed on shaft 16 to drive compressor 14, which is also fixed on shaft 16.

The described supercharger arrangements could include additional compressors (e.g., three or four) on the same axle or shaft. Also, multiple supercharger arrangements could be driven in tandem using multiple pulleys and belts and/or multiple drive shafts.

The above description is intended to be illustrative, not restrictive. The scope of the invention should be determined with reference to the appended claims along with the full scope of equivalents. It is anticipated and intended that future developments will occur in the art, and that the disclosed devices, kits and methods will be incorporated into such future embodiments. Thus, the invention is capable of modification and variation and is limited only by the following claims.

What is claimed is:

1. A supercharger comprising:
a first compressor having a first compressor wheel fixed on a rotatable shaft;
a second compressor having a second compressor wheel fixed on the rotatable shaft; and
a mechanical linkage for transmitting power from a running internal combustion engine to the rotatable shaft to drive the compressor wheels.

2. The supercharger of claim 1, further comprising an air inlet for the first compressor and an air inlet for the second compressor, wherein the air inlet for the first compressor is parallel with the air inlet for the second compressor.

3. The supercharger of claim 1, further comprising an air outlet for the first compressor and an air outlet for the second compressor, wherein the air outlet for the first compressor is parallel with the air outlet for the second outlet.

4. The supercharger of claim 1, wherein the first compressor has a first housing defining a first volute and the second compressor has a second housing defining a second volute, wherein the first and second volutes are substantially mirror images with respect to a plane bisecting the axial direction of the shaft.

5. The supercharger of claim 1, wherein the first compressor wheel is substantially a mirror image of the second compressor wheel with respect to a plane bisecting the axial direction of the shaft.

6. The supercharger of claim 2, further comprising an air outlet for the first compressor and an air outlet for the second compressor, wherein the air outlet for the first compressor is parallel with the air outlet for the second outlet.

7. The supercharger of claim 6, wherein the first compressor has a first housing defining a first volute and the second compressor has a second housing defining a second volute, wherein the first and second volutes are substantially mirror images with respect to a plane bisecting the axial direction of the shaft.

8. The supercharger of claim 7, wherein the first compressor wheel is substantially a mirror image of the second compressor wheel with respect to a plane bisecting the axial direction of the shaft.

9. A supercharged internal combustion engine system, comprising:
an internal combustion engine;
a first compressor having a first compressor wheel fixed on a rotatable shaft;
a second compressor having a second compressor wheel fixed on the rotatable shaft; and
a mechanical linkage for transmitting power from the engine to the rotatable shaft.

10. The system of claim 9, further comprising conduit for combining and conveying compressed air from the first compressor and the second compressor to an air intake manifold of the engine.

11. The system of claim 9, further comprising an air inlet for the first compressor and an air inlet for the second compressor, wherein the air inlet for the first compressor is parallel with the air inlet for the second compressor.

12. The system of claim 9, further comprising an air outlet for the first compressor and an air outlet for the second compressor, wherein the air outlet for the first compressor is parallel with the air outlet for the second outlet.

13. The system of claim 9, wherein the first compressor has a first housing defining a first volute and the second compressor has a second housing defining a second volute, wherein the first and second volutes are substantially mirror images with respect to a plane bisecting the axial direction of the shaft.

14. The system of claim 9, wherein the first compressor wheel is substantially a mirror image of the second compressor wheel with respect to a plane bisecting the axial direction of the shaft.

15. The system of claim 12, further comprising an air outlet for the first compressor and an air outlet for the second compressor, wherein the air outlet for the first compressor is parallel with the air outlet for the second outlet.

16. The system of claim 13, wherein the first compressor has a first housing defining a first volute and the second compressor has a second housing defining a second volute, wherein the first and second volutes are substantially mirror images with respect to a plane bisecting the axial direction of the shaft.

17. The system of claim 14, wherein the first compressor wheel is substantially a mirror image of the second compressor wheel with respect to a plane bisecting the axial direction of the shaft.

18. The system of claim 17, further comprising conduit for combining and conveying compressed air from the first compressor and the second compressor to the air intake manifold.
